(19) United States
(12) Patent Application Publication
(10) Pub. No.: US 2006/0195325 A1
(43) Pub. Date: Aug. 31, 2006

(54) Data retrieval system

(76) Inventors: Richard E Tateson, Woodbridge, Suffolk (GB); Erwin R Bonsma, Suffolk (GB); Cefn R. Hoile, Suffolk (GB); Mark A Shackleton, Suffolk (GB)

Correspondence Address: NIXON & VANDERHYE, PC, 901 NORTH GLEBE ROAD, 11TH FLOOR, ARLINGTON, VA, 22203, US

(21) Appl. No.: 10/550,203

(22) PCT Filed: Dec. 2, 2003
(86) PCT No.: PCT/GB03/05259

§ 371 Date: Sep. 21, 2005

(30) Foreign Application Priority Data
Mar. 27, 2003 (GB) 0307148.7

(51) Int. Cl. G06Q 99/00

(52) U.S. Cl. 705/1

(57) ABSTRACT

A browsing process is driven by user interaction. The user is presented with a selection of items 511, 512, . . . etc from a range. The user can give inputs representing interest in one or other of the items displayed. The inputs represent rewards, which are distributed to attribute data items or “keywords” associated with the display items. These keywords are transparent to the user, but represent characteristics of the display items with which they are associated. The browsing system selects items for display according to a probabilistic function weighted to favour those having the keywords which have accrued the highest number of rewards, these being the display items having the most keywords in common with display items previously rewarded by the user during the browsing session. Partial or negative weightings may also be applied to the keyword associations, which are also taken into account in the selection process.

This invention relates to data retrieval systems, and in particular to systems for assisting users to make a selection from a large range of available items. It has application in searchable databases in which there are a large number of variables to consider and the user needs freedom to search according to his own preferred criteria, but in which the database is too large, or the user's criteria too poorly defined, for a fully structured search to be possible.

In searchable databases a searcher is generally constrained to navigate along a branching decision ‘tree’ towards a destination. This is a good method for searching towards a known objective. However, the searcher is entirely at the mercy of the database's categorisation and will be unlikely to make serendipitous finds, or to form a general impression of what is available and thus direct his choices (a common strategy when shopping for example). Because paths must be retraced to arrive at different destinations, such systems are less suitable for less structured searching (“browsing”) where the objective is less clearly defined, or where several objectives may need to be inspected before a final choice can be made.

The shortcomings of online searching are magnified still further when the bandwidth of the link between the user and the database is low. An attempt to ‘browse’ an online database via a low bandwidth modem, for example on a mobile connection, typically consists of a pause while the homepage loads, a relatively rapid selection by the searcher of a section within the database, another pause while the section page loads, rapid selection of a category of items within the section, a further pause, and so on for each level of the structure.

According to the applicant's International Patent Application WO02/080025 there is provided a method of selecting items from a database for display, comprising the steps of:

generating data indicative of the similarity between each item and other items in the database;

receiving an input identifying a first item in said database;

generating an evolved specification, identifying a predetermined degree of similarity to the first item,

selecting an item in the database meeting the evolved specification,

displaying the selected second item.

This prior art process, when allowed to repeat itself iteratively, allows the product selection process to perform an evolutionary search strategy with the user acting as the selective pressure, using “mutations” based on the most recent selection or selections. Such a process can create a serendipitous exploration of ‘search space’, more akin to the natural browsing process used in a shop or library. Individual items on display are rewarded, the rewards then driving the search for new items to display.

In this prior art system links are established between items in the search space, according to attributes that the items have in common. Items are selected for display according to the links that exist between them and the items identified by the user. Thus, if a user identifies items having a given attribute, such as a specific colour, as being of interest, then the next selection will include items that are linked to those previously identified by virtue of their shared attribute (colour).

The system described in this prior art patent specification requires predetermined links to be included in the database. This requires a deep understanding (theoretical or empirical) of what attributes are likely to generate useful links There are also difficulties in applying the system to attributes such as prices, which are not Boolean (present/absent) in nature but exist on a scale.

Furthermore, there are circumstances where background information is needed to allow the user to assess the suitability of the items actually available, whilst the prior art system is most suited for circumstances where the available items are readily displayed. For example, when selecting goods such as clothes or motor cars it is usually only necessary to study the collection of items available to buy. However, when choosing a service, such as a holiday, there may be factors external to the packages actually on offer, such as availability of local amenities, climate, etc, that are at least as important as the facilities that form part of the package on offer. It is therefore necessary to browse guide books to home in on a type of holiday, or destination, before finding a specific holiday package to purchase which meets the chosen criteria for activities, location etc. Such considerations are also significant in other situations, such as when purchasing a house.

The present invention facilitates this rather different type of selection process by using a development of the technical methodology used in the earlier patent application, in conjunction with a modified user interface.

According to the present invention, there is provided apparatus for selecting items from a product database, the apparatus comprising:

a display database for storing a set of display items,

data-storage means for storing attribute data items each associated with one or more of the display items;

data-storage means for storing a score value for each attribute data item;

means for displaying a subset of the display items selected from the display database;

means for amending the score values in response to the user inputs

means for retrieving, from the data-storage means, attribute data items associated with any display item

means for retrieving from the display database, one or more display items selected in accordance with the score values associated with attribute data items,

output means for displaying an output identifying the selected further second display item or items.

According to another aspect, there is also provided a method of selecting items from a database, comprising the steps of:

displaying a set of display items selected from a display database,

storing attribute data items each associated with one or more of the display items;

receiving an input identifying a first display item selected from the displayed subset;

retrieving, from the data-storage means, attribute data items associated with the display item identified in the user input,

altering score values associated with the attribute data items in the light of user input

selecting one or more further display items associated with the retrieved attribute data items, and,

displaying the selected display item.

In a preferred arrangement, the set of display items are not limited to actual products that may be selected, but can include information that is associated with such products. The invention also extends to a computer program for performing the method of the invention, and to a computer program product directly loadable into the internal memory of a computer, comprising software code portions for performing the steps of the method when the product is run on a computer.

The invention also extends to a computer program product stored on a computer usable medium, comprising:

computer-readable program means for causing a computer to generate a display of a set of display items selected from a display database,

computer-readable program means for causing the computer to store a set of attribute attribute data items each associated with one or more of the display items;

computer-readable program means for causing the computer to respond to an input identifying a first display item, selected from the currently displayed subset;

computer-readable program means for causing the computer to retrieve, from the data-storage means, attribute data items associated with the display item identified in the user input,

computer-readable program means for altering score values associated with attribute data items according to user input

computer-readable program means for causing the computer to select one or more further display items based on the score values of attribute data items associated with each display item,

and computer-readable program means for causing the computer to generate a display of the selected further display item.

The further display items that are selected will tend to be those that have more attribute data items in common with the originally identified display item. The attribute data items each have a value or ‘score’ which is altered in the light of user interaction throughout the browsing session. The attribute data items may be associated with the display items using real-value weights (i.e. taking values which may take values other than 1 or 0), which modify the generation of score values and the creation of an aggregate score. Whenever a new item is to be displayed the attribute data item values are used to calculate an aggregate value for some or all the display items. For example the simplest way to derive a display item score would be to sum the score values of all attribute data items which are associated with that display item. One or more of the display items may be selected using a probabilistic function, such that the aggregate score value of a display item determines the probability of its selection. This allows the search to be focused towards items of interest to the user while also allowing serendipitous discoveries.

As in the previous invention, the browsing process is driven by user interaction. The user is presented with a selection of items from a range. The user can give those items ‘rewards’. In the prior art system these rewards alter a ‘reward value’ allocated to each item in the range according its similarity to the items that have been rewarded. The measure of similarity is not visible to the user, but the reward value allocated to an item affects the likelihood that it will subsequently be displayed to the user. The user continues browsing, and the set of items presented should become ‘enriched’ with items related to the user's preferences. Rewards can be positive or negative, the latter serving to reduce the likelihood of similar items being displayed.

In the present invention the rewards are allocated to attribute data items associated with the display items, instead of to the display items themselves. These attribute data items represent characteristics of the display items with which they are associated. They may be considered as “keywords”, but they do not necessarily have to be stored in linguistic form as their use is transparent to the user. The items selected for display are more likely to be those that have the highest number of keywords in common with the display items rewarded by the user during the browsing session. If partial or negative weightings are applied to the keyword associations, these are also taken into account in the selection process.

Users may also be allowed to select display items negatively, in order to indicate a preference not to be offered similar items.

This invention allows a more versatile selection process. It is not necessary for the service provider to identify all the links between display items every time a new item is added or removed from the list of those offered. When an item is added to the display database, it is simply characterised by a set of keywords (attributes), which indirectly link it to other items which may be of interest to the same searcher.

The invention also allows the user to work with a more diverse set of items, including items that can only be used to drive browsing but not actually ‘purchased’. The display items may therefore include abstract concepts representing higher-level item descriptors, suggestions, and other properties related to the keywords associated with the display items selected, as well as the display items (products) themselves. The term “display” is used in this specification to mean any form of presenting information to a user. It is not limited to pictorial images, and may include audio or Braille outputs for example.

By tracking a user's activities, as measured by the keyword scores, a user profile may be determined which may be used by the operator of the system to tailor other services to the individual user. Thus, in a future session, the database may start by offering the user display items associated with the data items (keywords) previously associated with the user from a previous session, notwithstanding any changes that may have taken place in the catalogue of display items since the previous session, or any specific constraints on the search that may be imposed by the user for individual sessions.

Embodiments of the invention will now be described by way of example, with reference to the drawings, in which:

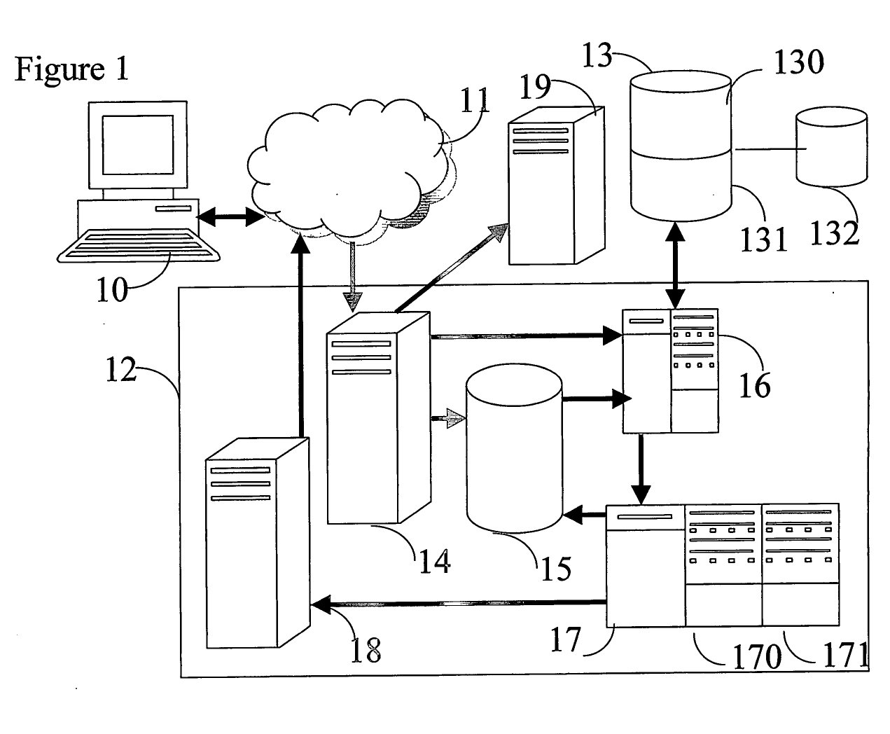

FIG. 1 illustrates schematically the inter-relationships between the various elements that co-operate to perform the invention;

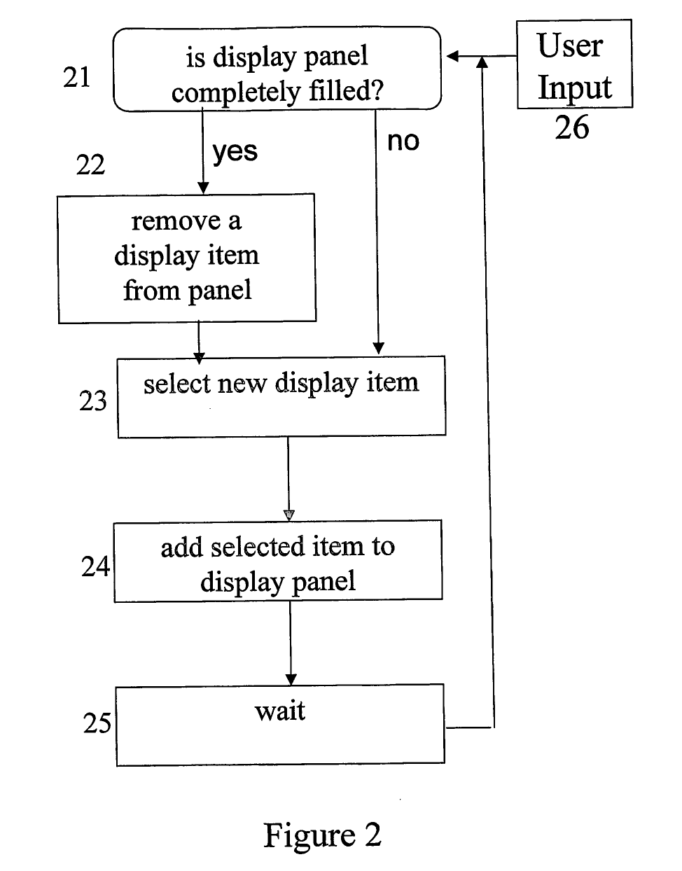

FIGS. 2 to 4 are flow charts illustrating the processes performed by an embodiment of the invention, more specifically;

FIG. 2 illustrates the periodic update of display items shown in display panel

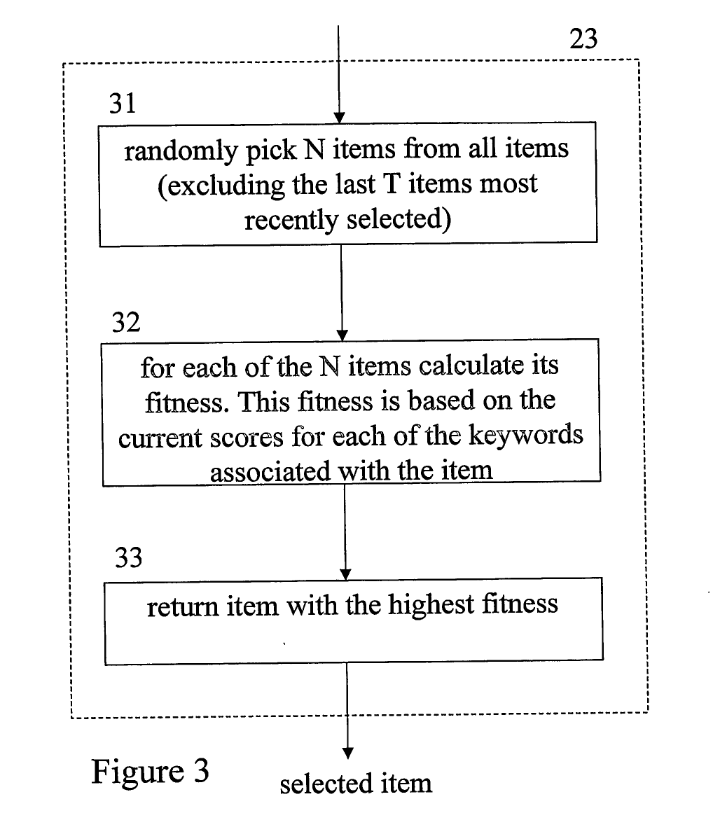

FIG. 3 illustrates an example of item selection based on user feedback

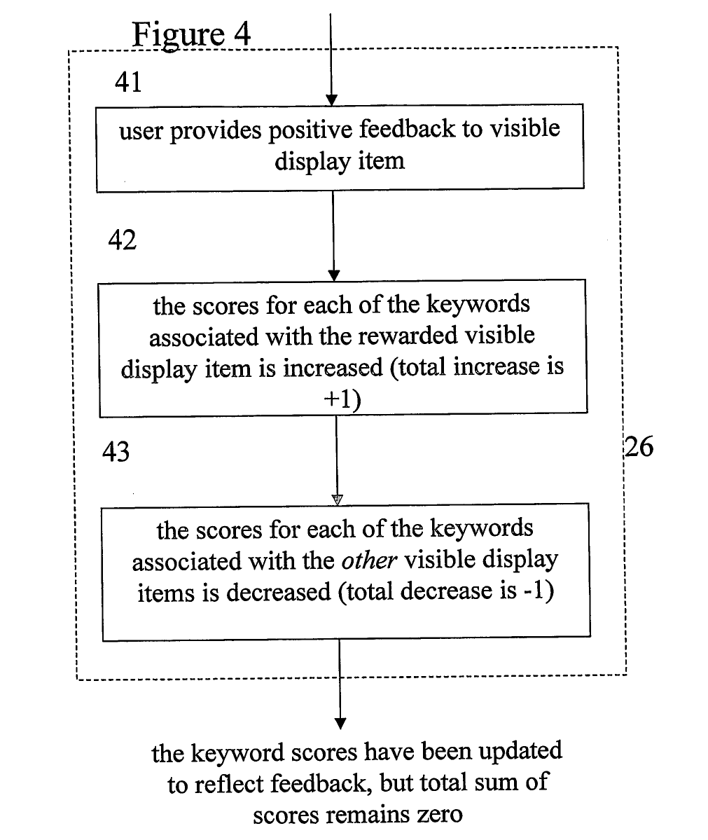

FIG. 4 illustrates the use of positive user feedback to affect keyword scores

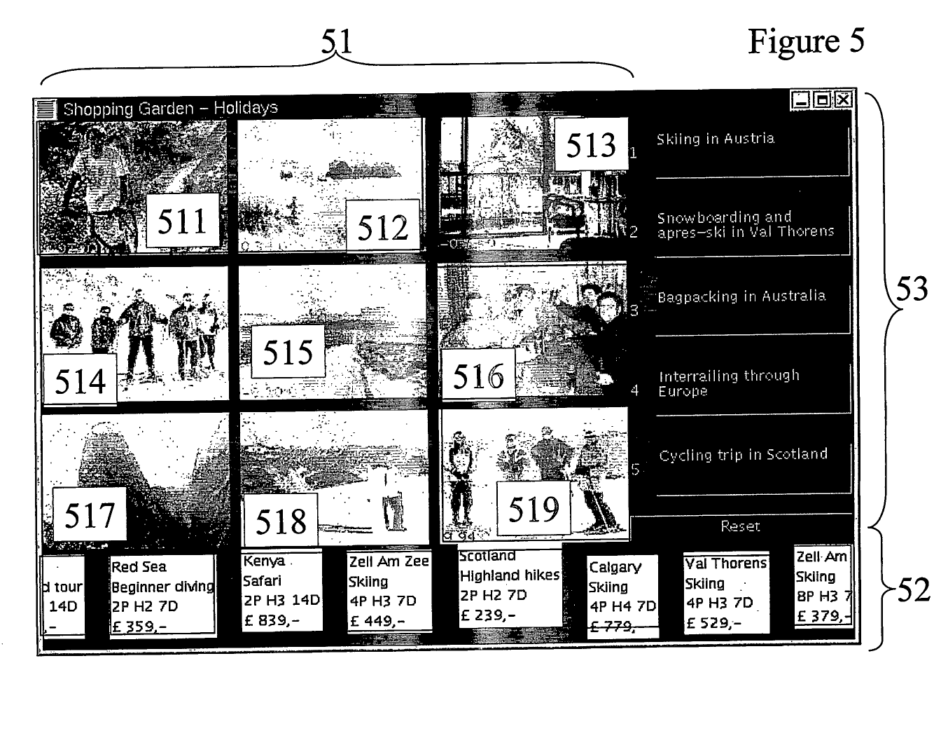

FIG. 5 illustrates a typical display that may appear during an illustrative run of the process.

FIG. 1 illustrates a user terminal 10 connected through a communications network 11 such as a low-bandwidth telephone connection to a server 12. The server has access to a database 13, and itself comprises a number of subsystems, which will typically be implemented by software. These subsystems include a receive port 14, a session recording database 15, a processor 16, a selection processor 17, and an output port 18. An order-processing server 19 is also associated with the system. This embodiment is similar to that of the applicant's earlier application, but the display database 13 now comprises two subsidiary databases: a concept display database 130 and a product display database 131, and a further store 132 of attributes associated with the items stored in the subsidiary databases 130, 131. The attributes may be stored in a separate database 132, as shown, or as attributes of the data items in the two subsidiary databases 130, 131.

The selection processer 17 also differs from that of the prior art system, in that it has an concept selection subsystem 170, and a product selection subsystem 171, each co-operating with the processor 16 and the respective display database 130, 131 to select concept display items and product display items from the respective databases.

It should be understood that the distribution of the elements may be varied. For example a client server, interposed between the network 11 and main server 12, may perform some of the functions performed by the terminal 10 in the described embodiment. Alternatively, the process could be run on the user terminal 10, accessing the data directly from an online database 13.

The display database 130 stores a catalogue of all the display items available for inspection, classified by a large number of attributes. The product database 131 stores a catalogue of all the product items available for inspection, classified by the same attributes, or a subset of them.

The product items are of course limited to what is available to purchase. There may be many different types of display items, but they will all be something that can be displayed in some form, such as visually (including, but not limited to, text), as sound fragments, or in tactile form (e.g. Braille characters). For ease of description, it will be assumed that in the present embodiment they are all visual images, and are represented on a screen 5 (FIG. 5)

The user interface consists of different screen areas or ‘panels’ which allow different kinds of interactivity. Three different panel types 51, 52, 53 can be distinguished. The first type, containing display items 511, 512, 513, . . . 519 is a feedback panel, showing concept images which may be associated with different types of product of the kind being searched for. In the simplified illustrated example shown in FIG. 5 a number of items, identified by the characters 511, 512, 513, . . . 519, are available for display. These are stored on the display database 130 each with a number of associated attributes or “keywords”.

In this embodiment the application is for booking holidays. The concept images can be very varied and may include photographs of scenes such as: deserted beaches, wildlife, amusement parks, art, architecture, people skiing, night clubs, famous landmarks, etc. The concept images shown in this panel are periodically changed, as will be described wih reference to FIGS. 2 and 3. The feedback panel 51 allows users to evaluate the concepts depicted in the images, as will be described in more detail with reference to FIG. 4.

The second type of panel 52 is a product display panel. The product display panel also depicts items, but the user does not directly evaluate these items. However, the user may interact with the product items in other ways. For instance, each item could represent an article that can be purchased, and the user may be able to buy the article or find out more about it by clicking on its representation.

The items that appear in the feedback and product display panels are selected by the system with a bias towards the perceived user preferences as indicated by the user's response to the feedback panels. That is to say, the user provides feedback so that the items in each of the panels will match the user's preferences more closely.

Throughout the browsing session display items are selected from the display database according to a probabilistic selection process where an aggregate score for each display item, which is itself derived from the keyword scores of all keywords associated with that item, is used to affect the chance of an item being selected. In a new browsing session, with no ‘history’ of the user recorded from a previous session, items are initially displayed at random because all keyword scores are zero and there is therefore no bias operating on the probabilistic selection process. The user can passively observe items entering the display as long as he likes, but at any time the user may identify an item of interest to him. Such an item would be one that attracts the user as being of a kind worthy of further consideration, for example the item 511 in the display of FIG. 5, in which case the user would interact to ‘reward’ that item. Alternatively the item may be one which the user particularly dislikes, in which case the user would administer a ‘penalising’ interaction.

This process will now be explained in more detail with reference to the Figures. A searching session operates as follows. The user of the terminal 10 opens a search space or “garden” (new or pre-existing) with a descriptor, which may be general (e.g. ‘holidays’) or more specific (e.g. “Spain”, or “family”). Certain other limitations may be added to limit the variety of items available for display: for example the user may specify dates, to ensure items are only offered if they meet any absolute criteria specified by the user. Subject to any such predetermined limitations, the selection processor 17 selects display items, initially at random, from the display database 130 and passes them to the output port 18 for onward transmission to the user. To make the best use of the narrow bandwidth available on most home user's equipment, the user terminal 10 may include a buffer store so that it can continuously update the display screen with items from the display database 130. New items then start arriving in the display (description plus picture wherever appropriate). Initially these items are randomly selected from all items within the database, subject to any initial limitations imposed.

FIG. 2 shows the iterative process during a browsing session. In step 21 it is determined whether the display panel is already full of items. In the example shown in FIG. 5, the display panel 51 is full when nine images (511 to 519) are present.

If the display panel is full, an item must be removed to make room for a new item (step 22). One way of choosing the item to remove is to choose the item which has been displayed longest (a first-in, first-out approach). It is also possible to make the choice probabilistic, or relate it to the user's preferences.

Now that there is room in the display panel, a new item is selected (step 23) Items are selected to show in the feedback panel 51 (and the display panels 52, 53) such that those that are shown match the user's preferences. To do so, it is first of all helpful to associate a fitness with each item. The fitness value can be used to select items in various ways, e.g.:

Tournament selection: a number of items are selected at random from the total available items. Of these, the item with the highest fitness becomes the chosen item.

Roulette selection: an item is chosen from among the total available items with a probability proportional to the fitness (note: as this process cannot cope with negative fitness, normalisation of fitness values to make all values positive is required).

Soft Tournament: a number of items are selected at random and then roulette selection is applied to that selection to produce a final selected item.

In addition, these selection strategies can be extended with a taboo mechanism. Thus, the selection can exclude any of the T items that were most recently selected, where T is a positive number. The process is shown in more detail in FIG. 3. This example uses ‘Tournament selection with Taboo’, where ‘N’ is the size of the ‘tournament’ and ‘T’ is the length of the ‘taboo list’.

In step 31, the selection processor 170 selects a number N of items from all available items (i.e. items which meet any criteria set out by the user at the start of the session). Initially every item has an equal chance of being selected, except that items which have been selected within a predetermined number T of recent iterations are not permitted to be selected again.

In step 32 each of the selected N items has its fitness calculated according to the formula below. This fitness is an aggregate of all the scores for keywords associated with the item. When a session is started, all keyword scores are set to zero and hence all items have zero fitness. When the user has interacted with the items, as will be discussed with reference to FIG. 4, some keywords will have non-zero scores and hence some items will have non-zero fitness. It is at this point that the selection of the next item to display deviates from a uniform random process.

The fitness for an item can be given by the formula:

$${‖ K ‖}^{- β} {\sum }_{k ∈ K} sign ( s ( k ) ) {\vert s ( k ) \vert}^{α}$$

Where:
K is the set of keywords associated with the item
∥K∥ is the number of keywords associated with the item
s(k) the score for keyword k
sign(x), a function that returns −1 when x<0, and returns 1 otherwise

α is a parameter which allows a non-linear effect of keyword scores. The default value for alpha is ‘1’ which means that the scores of all keywords are summed without adjustment. For example two keywords with scores of −1 would exactly cancel out a single keyword with a score of 2. Altering this parameter allows us to increase (or decrease) the effect of scores which are further from the starting value (zero). For example if α is set to ‘2’ an item with a single keyword scored 2 and two keywords scored −1 would still have a positive aggregate score.

β is a parameter which controls the effect of the total number of keywords associated with a display item. Again the default value is ‘1’ which means that the sum of keyword scores is divided by the number of keywords to give the aggregate score. Setting β below ‘1’ mitigates against the slow response which can occur (especially early in the browsing session) if each display item has several keywords. The majority of zero-score keywords ‘dilute’ the influence of the minority of keywords which have significant scores.

Together, these two parameters α and β allow some ‘tuning’ of the algorithm in terms of the trade-off between ‘exploration’ (browsing widely around the available database) and ‘exploitation’ (focusing on user interests).

We have found it effective, in the holiday case, to set α=1.2 and β=0.8. This has the effect of biasing the process somewhat towards ‘exploitation’: rewarded and penalised keywords have a slightly disproportionate effect and the dilution of having several associated keywords is reduced. Hence the focusing of the browsing in response to user interaction is quicker.

Tuning via these parameters is particularly effective thanks to the ‘zero sum’ feature of the keyword scores. The sum of all keyword scores is always zero, so the average keyword score remains zero even as some keywords deviate significantly. Hence we don't have to add correcting factors to the equation to allow for either ‘creep’ of the average score (where the average might drift up as people do more rewarding than penalising) or the fact that the fixed average is non-zero (if the average score was 1, for example, altering the value of β becomes problematic because part of its function would simply be to ensure that a display item couldn't establish an above-average fitness simply because it had very many keywords associated with it).

The item with the highest fitness value is selected (step 33) and is returned to the display update process of FIG. 2 (step 23), for display in the display panel (step 24). In the event of equal scores for the highest fitness items, one of those highest fitness items is selected at random (with equal probability).

In cases where bandwidth is high, it is desirable to introduce a delay (step 25) so that the user has time to interact with items (step 26) before they are replaced with new ones. The length of delay can be fixed, or under user control, or can be a random length according to any desired probability distribution. In cases where the bandwidth linking the user terminal 10 with the output port 18 is low, the delay introduced by data transfer itself may already be optimal (or longer), in which case no additional pause is necessary.

The images in the feedback panel are therefore replaced one at a time, the image that has been displayed in the panel the longest being replaced by another image. The image that is shown in its place is selected based on the user's feedback. There are of course other ways of refreshing the images in the feedback panel, such as in uniformly random order, or in random order biased according to some function of the length of time the image has been on the screen or the current degree of reward attached to that image. The way described here has the advantage that it is easy for the user to understand which image will be replaced next, which helps the user to give feedback.

The loop shown in FIG. 2 will continue to operate in the absence of user interaction. The user can be provided with the ability to pause the session, and hence suspend the loop.

A typical display is shown in FIG. 5. From the display shown in FIG. 5, which is being updated regularly with new display items selected as described, the user selects a display item from those currently displayed 511 . . . 519.

FIG. 4 illustrates the events occurring when the user interacts with one of the displayed items (step 26), showing how user feedback affects the keyword scores, and thereby indirectly affecting the subsequent selection of display and product items. Although shown as occurring during the pause at the end of the update process (step 25), this step can happen at any time during the loop shown in FIG. 2, although the effects of the interaction will not be seen in the display until the next new item is selected (step 23) and added to the display (step 24). For illustrative purposes, the feedback is shown as positive, (“approval” or “reward”) but negative feedback is also possible.

The user initiates the process by giving feedback on one of the displayed items (step 41). This is typically done by “clicking” on an image using a computer mouse. The mouse button that is clicked (right or left) could distinguish if the feedback is positive or negative. Alternatively, it may depend on which part of the item was clicked, or a pop-up menu may appear inviting positive or negative feedback according to clickable options on the menu.

When a user selects an item a signal is transmitted over the communications link 11 to the receive port 14, causing a display item identifier to be stored in the session recording database 15. The processor 16 then retrieves the keywords of the selected item 511 stored in the database 130. It then uses the keywords associated with the selected item to bias the random process of choosing the next item to be displayed. The keyword scores are then updated (step 42). If the feedback is positive, a ‘reward’ totalling +1 is apportioned amongst the keywords relating to that item (step 42). For example if there are two keywords associated with the item selected, each will have its score increased by 0.5.

In addition a signal is transmitted to identify the display items which were on display at the moment of user interaction but were not rewarded. Keywords associated with these display items will have the scores altered in the opposite sense to the keywords associated with the selected item (step 43) A ‘penalty’ totalling −1 is apportioned among the keywords associated with all the items currently being displayed, except for the one that has just been rewarded by the user (step 43).

More specifically, when a user provides positive feedback on a specific item, a positive reward R, is distributed equally across the keywords associated with the item. In other words, if the item has n keywords associated with it, the score of each keyword is increased by R/n. At the same time, a penalty −R is distributed equally across the other items in the feedback panel. So if the feedback panel contains M other items, each item is given a penalty of −R/M. Once again, for each item the penalty is distributed equally across the keywords associated with it. So if one of these items has m keywords associated with it, the score of each of these keywords is decreased by R/(M m).

Similarly, when a user provides negative feedback on a specific item, a negative penalty P, with P<0, is distributed equally across the keywords associated with the item. Furthermore, a reward −P is distributed equally across the other items in the feedback panel, similar to how this is done for positive feedback.

There are of course other ways of handling feedback and distributing rewards and penalties to keywords. However, a useful feature of the above mechanism is that the sum of all keyword scores remains zero. Why this is beneficial will be briefly discussed after the selection of items has been described.

Note that any keywords common to the rewarded display item and the other items currently displayed will take a share of both the reward and the penalty. Keywords peculiar to the selected item, and therefore more suitable for differentiating the rewarded item from the others, therefore gain a greater net reward than keywords less capable of such differentiation.

Thus, when the user rewards a displayed item, the keywords associated with that item will have their scores increased and the keywords associated with all other simultaneously-displayed items will have their scores decreased.

The keyword scores have now been adjusted to reflect the user's preferences. It is these keyword scores which will be used to calculate the ‘fitness’ of the items in the next iteration of the tournament (step 32). This is the point at which the arrival of new display items deviates from a random sample. The next time the display is updated with a new display item, the selection process will operate exactly as before, but now keyword scores are no longer all zero and so the probabilistic selection process will be biased towards choosing display items which are associated with keywords with scores greater than zero. However, the total sum of keyword scores remains zero throughout the browsing session because the rewards and penalties resulting from each user interaction always exactly cancel out. The actions of the user act only to redistribute scores, not to add to the sum.

Examples of keywords are shown in Tables 1 and 2, but it should be understood that the attributes need not be linguistic elements.

TABLE 1
Holiday ideas and the associated keywords

| Holiday Idea | Keywords |
|---|---|
| On safari in Africa | Nature sun tropical |
| Clubbing in Ibiza | beach 18to30 sun nightlife Mediterranean |
| | Europe |
| Windsurfing in Hawaii | beach active sun water sports tropical |
| Mediterranean Cruise | sun Mediterranean water CruiseAndBigShips |
| Cycling trip in Scotland | active bicycle mountains forest |
| Disney world in Florida | family sun USA themepark |

TABLE 2
Specific holiday offer information and the associated keywords.

| | |
|---|---|
| destination | Majorca |
| Info | sun and beach |
| Price | 299 |
| keywords | Mediterranean beach sun Europe |
| destination | Majorca |
| Info | sun and beach |
| Price | 345 |
| keywords | Mediterranean beach sun Europe |
| destination | Majorca |
| Info | sun and beach |
| Price | 249 |
| keywords | Mediterranean beach sun Europe |
| destination | Majorca |
| Info | sun and beach |
| Price | 299 |
| keywords | Mediterranean beach sun Europe |
| destination | Paris |
| Info | weekend break |
| Price | 199 |
| keywords | city Paris Europe |
| destination | Paris |
| Info | weekend break |
| Price | 249 |
| keywords | city Paris Europe |

In a slightly more complex extension of the method described above, it is possible to accommodate the fact that in addition to the idea of having a keyword either associated with an item, or not associated with that item, it can be desirable to allow real-valued weights (having values which may be other than 1 or 0) to be placed on the strength of association. For example we might want to say that a picture of a holiday resort corresponds simply to the keywords ‘sun’, ‘snow’ and ‘skiing’ or we might want to say that it corresponds to ‘0.5 sun’, ‘0.9 snow’ and ‘1.0 skiing’.

To allow this to be done, some alterations to the preceding description are necessary as described below. Note that what follows is a more general method which allows real-valued weights, but operates exactly the same as the simpler description above if all weights are set to 1 or 0. This method can be further generalised to allow the use of negative values for the weights, but in the description that follows the weights are constrained to be greater than or equal to zero.

When a user provides positive feedback on a specific item, a positive reward R, is distributed across the keywords associated with the item. Each keyword receives a portion of that reward proportional to the weight associating that keyword with the item. In other words, if the item has n keywords associated with it, and if the weight associating a keyword with the item is w, the score of that keyword is increased by the product of R and w divided by the sum of all the keyword weights associated with the item.
s(k)ₜ₊₁=s(k)ₜ+(w(i,k)R)/(Σw(i,j))
where:
s(k)ₜ₊₁ is the score for keyword k after reward has been allocated
s(k)ₜ is the score for keyword k before reward has been allocated
w(i,k) is the weight associating item i with keyword k
Σw(i,j) is the sum of all the weights associating all keywords with item i

At the same time, a penalty −R is distributed across the other items in the feedback panel. So if the feedback panel contains M other items, each item is given a penalty of −R/M. Once again, for each item the penalty is distributed across the keywords associated with it. Each keyword receives a portion of that penalty proportional to the weight associating that keyword with the item. So if one of these items has m keywords associated with it, and if the weight associating a keyword with the item is w, the score of that keyword is decreased by the product of w and R/M divided by the sum of all keyword weights associated with the item.
s(k)ₜ₊₁=s(k)ₜ−(w(i,k)R)/(MΣw(i,j))
where:
s(k)ₜ₊₁ is the score for keyword k after penalty has been allocated
s(k)ₜ is the score for keyword k before penalty has been allocated
w(i,k) is the weight associating item i with keyword k
Σw(i,j) is the sum of all the weights associating all keywords with item i
M is the number of other items in the feedback panel

Similarly, when a user provides negative feedback on a specific item, a negative penalty P, with P<0, is distributed across the keywords associated with the item. Furthermore, a reward −P is distributed equally across the other items in the feedback panel, similar to how this is done for positive feedback.

Items are selected to show in the feedback panel 51 (and the display panels 52, 53) such that those that are shown match the user's preferences. To do so, it is first of all helpful to associate a fitness with each item. The fitness for an item i can be given by the formula:
Fᵢ=(Σw(i,k))^{-β}Σsign(s(k))|s(k)|^{α}w(i,k)
where:
w(i,k) is the weight of association between item i and keyword k
Σw (i,k) is the sum of all weights for keywords associated with item i
s(k) the score for keyword k
sign(x), a function that returns −1 when x<0, and returns 1 otherwise
α and β are two parameters defined as before

As the session proceeds, the display will be increasingly populated with display items which are associated with keywords with high scores. Those keywords have high scores because, over the course of the browsing session, direct or indirect rewards have been applied to other display items which are also associated with those keywords. The evolved display therefore includes a mixture of items sharing some attributes with display items the user found interesting.

Instead of limiting the display 51, to nine items it is possible to allow tiling of items one over another so that the display panel is never full, but new items will gradually occlude older items. If this is done it becomes necessary to modify the way in which rewards and penalties are shared such that ‘displayed but not rewarded’ items are defined according to how recently they were added to the display (more akin to the audio file case described below) rather than whether they are simultaneously displayed on the screen with the rewarded item, as described for FIG. 4.

In addition to the main display panel 51, the present embodiment also includes a product display panel 52, which shows specific product offers, selected to match the user's preferences as expressed by the display panels selected by the user. The attributes used by the selection processor 170 are also passed to the second selection processor 171, so that the second selection processor 171 can select a new product display from the store 131 meeting those attributes. This product display is then transmitted to the user terminal 10 to update the product display panel 52. In the example above, these will be specific holiday packages. In this embodiment the panel 52 scrolls the products on offer from right to left, with new offers appearing at the right side of the panel. Each product display shows some information about the product, such as destination, date, price and type of accommodation. If the user selects a specific product by clicking on it a pop-up menu is generated. The user can use the menu to find out more about the selected product, or go directly to booking it through the order processing server 19 or, having established a general type of product may transfer to a conventional “tree” or branch structured search to make an actual selection.

There is also a third display panel 53, which shows generic ideas as opposed to specific products that can be booked. These are selected by the second selection server 171, also from the database 131 according to the current attributes. The collection from which they are selected is assembled such that the ideas are as varied as possible, and that no two ideas are too similar to each other. Example ideas are for instance: ‘surviving in the Amazon’ or ‘Sleepless in Amsterdam’. These ideas are updated after each user feedback event. The panel has several purposes. Firstly, because the panel is updated instantaneously, the user becomes immediately aware that giving feedback has an effect, which encourages the user to provide further feedback. Secondly, it gives a good idea of the user's preferences as perceived by the application. This demonstrates to users that the application identifies their preferences promptly, and further encourages them to interact with the application. Thirdly, these ideas may provide an alternative way for users to order a product. Users may click on ideas that they particularly like, and as a result, they may be taken to a web page where they can search for specific products of this type and/or get contact information for providers that specialise in this type of product.

In an alternative implementation, the supplementary panel 53 would be used to display a number of specific products that can be purchased, rather than generalised ideas. To avoid filling the panel with almost identical products (such as holidays differing only by departure date) offers are compared on the basis of attributes, such that only one example of a set of very similar products is displayed in the supplementary panel 53.

This process has the capability to capture complicated user preferences. In the case of holidays, user's preferences are multi-dimensional. They consist of many sub-preferences, which may be wholly or partly independent. These include: the weather (hot, warm, mild), amount of activity (ranging from very leisurely, such as sunbathing, to very active, in which case the preferred activities need to be established), where to go (regions of the world, specific countries, a specific city, or other constraints such as language), culture (a preference for paintings, history, music, popular culture), age group (young adults, elderly, family), type of accommodation (hotel, guesthouse, camping), amount of luxury, etc.

The process also has the capability to follow changes in user preference taking place during the process. For example, it may happen that the user initiates the process to look for a summer holiday. The user's feedback will tend to be directed towards active holidays and sun. It may therefore happen that the feedback panel will show an image associated with the keywords “active” and “sun”, but the image is a skiing scene. If this prompts the user to decide to redirect the search towards skiing holidays, the application should allow the user to explore this direction. Naturally, the concept images in the feedback panel and the product images (holiday offers) that are shown should not instantaneously all become “skiing” related. However, if the user continues to reward skiing-related images, the application will start to redirect itself according to the keywords associated with such images.

The process can be used to generate a user profile. The main aim of the process is to sell holidays, and do so by making the browsing experience as pleasant and effective as possible. However, after the user has given feedback, and hopefully booked a holiday, a useful side-effect would be if the user's preferences can be captured in a “useful” manner. This could be very valuable for marketing purposes, to allow the retailer to gather data about potential customers without the awkwardness of a questionnaire. It would also be useful more from the customer perspective, to allow a user to return at a later time and find their ‘profile’ ready and waiting.

The process may also be used to subtly promote items. Retailers often want to point customers towards particular purchases (e.g. to clear stock). This is often done in a clumsy and obvious way (‘bargain bucket’, ‘special of the week’) but could be much more subtly achieved as an additional bias on the probabilistic browsing mechanism.

The process may be used to help a group of users reach a consensus, without having to explicitly describe their desires and differences. For example two or more people could use an interactive browser together to find a holiday which they all like, without having to explain to each other, and a travel agent, what sort of holiday they each desire.

The feedback, reward and selection mechanism described in this embodiment have been chosen to make this possible. There are of course other ways to perform feedback, reward and selection. For instance, one way to track changing user preferences is to use an explicit decay mechanism, in which the user's most recent feedback is the most significant, and the older feedback events become gradually less significant. Although it allows the application to adapt to changing preferences, it has the disadvantage that it limits the ability to capture complicated user preferences. If the decay is such that the feedback event of “ten clicks ago” is effectively ignored, it is impossible to latch on to preferences that can only be accurately described by a collection of ten or more images/feedback events.

Three key features of the reward mechanism are:

a) the sum of all keywords scores is always zero

b) feedback is relative to the other items that are shown

c) there is no explicit decay.

Together a), b) and c) ensure that complicated preferences can be captured. Selection ensures that the feedback panel tends to show items that match the user preferences. This ensures that further feedback allows the user to “home in” even further by rewarding the item he likes best, and penalising the others slightly. Furthermore sub-preferences of the user that have not yet been spotted, can still be appended to the user's preferences. The scores of the keywords that represent these sub-preferences remain (close to) zero, as are most keyword scores. So as long as the selection of items to show in the feedback panel is fairly exploratory (e.g. a relatively small tournament size in tournament selection), these items are quite likely to be selected for display in the feedback panel, and can subsequently be rewarded by the user.

Features a) and b) also ensure that the application can latch on to changes in the user's preferences. They ensure that the keywords scores associated with the preferences expressed by the user cannot depart too much from the keyword scores of neutral items that have been selected for display but not yet scored by the user. The feedback panel will always display items that have some of these “neutral” keywords associated with it. Since feedback is relative to the other visible items, clicking on an item with, amongst others, a “neutral” keyword associated with it will particularly reinforce this keyword. If the item has some “popular” keywords associated with it, it is likely that some of the other visible items, which will be penalised, have the same “popular” keyword associated with it. As a result, the score of the “neutral” keyword will increase more than the score of the “popular” keywords that were also associated with the item.

As regards generating a user profile, after the user has been giving feedback for some time, the scores associated with all keywords reflect the user's preferences. Keywords with clear positive scores are “likes”, whereas keywords with negative scores are “dislikes”. Hence the ‘user profile’ is automatically generated in each session—at its simplest it is the list of keywords and their scores.

The final two desirable properties are very easily incorporated into this style of browsing, in a way which is much more difficult or impossible with other approaches:

The nature of a browsing process in which the next item to be shown is chosen according to a ‘biased, random’ mechanism, giving a very subtle contortion of the range of items on display to the user at any given moment. It would be very easy to bias the process such that certain items are more likely to appear, without this necessarily becoming obvious or intrusive on the user's browsing experience.

Multiple user browsing is also easily catered for. At its simplest, providing all users with a single interface through which they do their browsing simultaneously would achieve much of the desired consensus-generation. From the perspective of the browser there would still be a single user (‘The Smith Family’) and interaction (reward or penalty clicks) from any group member would be aggregated with the whole.

There are two cases in which this would not work so well, and both can be addressed. The first is the case where simultaneous browsing is not possible. Some members of the group will browse when others have finished. The simplest approach is to continue to treat the group as a single user, and allow the new group member to resume browsing from where the last member left off. Alternatively each new group member could start from a neutral initial state, regardless of whether they are the first or last of the group to do their browsing. When all members have browsed the keyword scores of all members can be aggregated and the ‘results’ display—either as a ranked list of holiday offers or ideas, or as a full interface possibly with the chance for further interaction from the whole group.

Another case in which even simultaneous browsing might not work as effectively as possible is where there is a significant disparity in the way in which the different members interact with the system, perhaps because of different degrees of familiarity with the system, or because they are connected through communications links having different capacities. If all clicks are aggregated as they are made as an apparent single user it is possible that one of the group members will dominate. This effect could be mitigated, assuming different group members are using different input devices, by tracking clicks from different users, and scaling the effect of a click as a function of the number of clicks already made by that group member. Alternatively, the rate at which each user may make inputs may be constrained.

A further domain of application for this invention will now be described, which is rather different from the image-based browsing embodiment described above, and hence which benefits from a brief example of its own. This is the use of the technique to browse audio files. The proposal here is to use the same fundamental idea of reward and penalty to alter the probability of ‘displaying’ (playing) items from the available catalogue. The principal difference is in the interface and the user interaction.

The display in this embodiment is an audio output, and the user experience is designed to resemble a radio which plays tunes, initially at random. The user has three buttons: ‘Kill’, ‘Stay’, and ‘Play’. “Kill” stops the current tune playing, and a new tune starts. “Stay” extends the play of the current tune by a predetermined period. “Play” causes the tune to play to the end, whereupon a new tune starts. In the absence of any interaction for a predetermined period, the current tune stops and a new tune starts. Behind the scenes, ‘Kill’ is acting as a penalty (negative reward), ‘Stay’ gives a modest reward, and ‘Play’ gives a large reward. These penaltys and rewards are used to alter the scores (based on keywords or other similarity measures) for the current tune and similar tunes. The next tune to be played is picked, as in the Holiday example, according to a biased random selection from the available set of items.

To preserve the concept of ‘implicit penalty’, which is implemented in the Holiday example by modest penalty of any image currently displayed when another image is rewarded, it is proposed to use the history of the audio ouputs presented. Reward of a tune, whether by Stay or Play, results in a penalty to the previous tune, and a smaller penalty to the tune before that etc. Conversely, implicit reward can be handled by applying a reward to a tune played before a ‘Killed’ tune. Note that these penaltys and rewards will be handed back regardless of whether the previously played tunes were themselves Played, Stayed or Killed. However the amount of penalty or reward would be set so that repeated reward or penalty of the items that follow could, at most, exactly cancel out the reward or penalty originally applied to that tune when it was actually being heard. The alternative form of implicit penalty, possibly also with some form of ‘Kill’, ‘Stay’ and ‘Play’, could be used in any situation where the user can only be evaluating one (or very few) item at a time. For example if images have to be large, and of high definition for their evaluation there might only be room on the screen for one or two at a time. The experience of the user should be that, from an initially rather hit and miss selection requiring many ‘Kills’, some ‘Stays’ and a few ‘Plays’, the selection becomes attuned to the user's preferences and gets an increasing number of hits.

As will be understood by those skilled in the art, any or all of the software used to implement the invention can be contained on various transmission and/or storage mediums, so that the program can be loaded onto one or more general purpose computers or could be downloaded over a computer network using a suitable transmission medium. The computer program may be embodied on any suitable carrier readable by a suitable computer input device, such as CD-ROM, optically readable marks, magnetic media, punched card or tape, or on an electromagnetic or optical signal.

1. Apparatus for selecting items from a product database, the apparatus comprising:
a display database for storing a set of display items,
data-storage means for storing attribute data items each associated with one or more of the display items;
data-storage means for storing a score value for each attribute data item;
means for displaying a subset of the display items selected from the display database;
means for amending the score values in response to the user inputs
means for retrieving, from the data-storage means, attribute data items associated with any display item
means for retrieving from the display database, one or more display items selected in accordance with the score values associated with attribute data items,
output means for displaying an output identifying the selected further second display item or items.

2. Apparatus according to claim 1, further input means for receiving a user input identifying a first display item selected from the displayed subset, and wherein the score values for each attribute data item can be altered in response to such user interaction

3. Apparatus according to claim 1 and 2, wherein the means for retrieval operate on the basis of assigning an aggregate score to each display item based on the current score values of attribute data items associated with that display item

4. Apparatus according to claim 2, wherein the means for retrieval comprises means for generating a probabilistic function, such that the current aggregate score of a display item determines the probability of its selection.

5. Apparatus according to claim 5, wherein provision is made for users to input both positive and negative reward values.

6. Apparatus according to claim 1, wherein the data storage means comprises means for storing real value weights associating attribute data items with display items

7. Apparatus according to claim 1, wherein the display includes non-visual elements.

8. Apparatus according to claim 1, further comprising user profile generation and retrieval means for recording attribute data associated with inputs made by individual users and using the attribute data to initialise further sessions operated by the same users.

9. A method of selecting items from a database, comprising the steps of:
displaying a set of display items selected from a display database,
storing attribute data items each associated with one or more of the display items;
storing a score value for each of the attribute data items,
updating the display at intervals with new display items
receiving an input identifying a first display item selected from the set of displayed items;
retrieving, from the data-storage means, attribute data items associated with the display item identified in the user input,
updating the score values of attribute data items in response to user input
continuing to update the display at intervals using the updated score values of attribute data items to bias the selection process.

10. A method according to claim 9, wherein the items selected for display are selected according to a process which uses the attribute data item scores to bias a probabilistic selection across the display items

11. A method according to claim 9, wherein each attribute data item has a score value which is altered according to user interaction with display items.

12. A method according to claim 11, wherein each display item is associated with a number of attribute data items, and where an aggregate score is created for that display item, using the score values of associated attribute data items.

13. Apparatus according to claim 11, wherein one or more of the display items may be selected using a probabilistic function, such that the aggregate score of claim 10 determines the probability of its selection.

14. A method according to claim 9 wherein user-generated reward values in respect of selected display items are used to generate associated score values for the attribute data items associated with the display item, the score values being used to create an aggregate score for associated display items and hence bias the probabilistic selection process

15. A method according to claim 14, wherein the attribute data items are associated with the display items using real-value weights which modify the generation of score values and the creation of an aggregate score.

16. A method according to claim 9, where the changes to attribute data item score values are so arranged that the sum of score values across all attribute data items is zero.

17. A method according to claim claim 9, wherein reward values may take both positive and negative values.

18. A method according to claim 9 wherein reward values may accrue not only to attribute data items associated with a display item selected by the user, but also to attribute data items associated with display items which were available for selection in competition with the selected item either by being simultaneously present on the display means or by having been recently displayed.

19. A method according to claim 18 wherein the reward accrued by attribute data items due to association with non-selected display items is negative where the selected display item reward is positive, and positive where the selected display item reward is negative.

20. A method according to claim 9, wherein the display includes non-visual elements.

21. A method according to claim 9, wherein user profiles are generated using the attribute data associated with the selections made by individual users.

22. A method according to claim 9 wherein a further set of display items exists which is not selectable by the user for amending the score values, the further display items being associated with attribute data items drawn from a set wholly or partly overlapping with the set of attribute data items associated with the interactive display items, the further display items being selected, according to the associated attribute data items, for display on a separate display means, or on a separate part of the display means used for interactive display items

23. A method according to claim 9 wherein a user may initiate a further type of interaction, such as purchase or request for further information, by selection of display items.

24. A computer program for performing the method of claim 9.

25. A computer program product directly loadable into the internal memory of a computer, comprising software code portions for performing the steps of the method of claim 9 when the product is run on a computer

26. A computer program product stored on a computer usable medium, comprising:
computer-readable program means for causing a computer to generate a display of a set of display items selected from a display database,
computer-readable program means for causing the computer to store a set of attribute data items each associated with one or more of the display items
computer-readable program means for causing the computer to respond to an input identifying a first display item, selected from the currently displayed set, computer-readable program means for causing the computer to retrieve, from the data-storage means, attribute data items associated with the display item identified in the user input,
computer-readable program means for causing the computer to select one or more further display items associated with the retrieved attribute data items, and
computer-readable program means for causing the computer to generate a display of the selected further display item.
